(19) United States
(12) Patent Application Publication
(10) Pub. No.: US 2025/0344771 A1
(43) Pub. Date: Nov. 13, 2025

(54) Aerosol Generation Device

(71) Applicant: JT International SA, Geneva (CH)

(72) Inventors: Alec Wright, Guildford (GB); Grzegorz Aleksander Pilatowicz, Grens (CH)

(73) Assignee: JT International SA, Geneva (CH)

(21) Appl. No.: 18/861,010

(22) PCT Filed: May 9, 2023
(86) PCT No.: PCT/EP2023/062254

§ 371 Date: Oct. 28, 2024

(30) Foreign Application Priority Data
May 9, 2022 (EP) 22172341.4

(51) Int. Cl. A24F 40/95; A24F 7/00; A24F 40/20; A24F 40/46; A24F 40/57; H05B 3/28

(52) U.S. Cl. CPC A24F 40/95; A24F 7/00; A24F 40/20; A24F 40/46; A24F 40/57; H05B 3/283

(57) ABSTRACT

An aerosol generation device includes a holding unit configured to receive and aerosolise an aerosol generating substrate, and a charging unit that is connectable to the holding unit. The holding unit includes a heater component to aerosolise the aerosol generating substrate, a first charge storage module to power the heater component, and a cavity into which the aerosol generating substrate is insertable for heating. The cavity is configured to receive an aerosol generating substrate that is substantially planar in shape. The charging unit includes a second charge storage module configured to charge the first charge storage module and power the heater component. The aerosol generation device further includes a controller configured to: when the holding unit is connected to the charging unit, pre-heat the heater component for an aerosolisation session by directing a power flow from the second charge storage module to the heater component.

### FIELD OF INVENTION

The present invention relates to aerosol generation devices, and more specifically aerosol generation device power systems.

### BACKGROUND

Aerosol generation devices such as electronic cigarettes and other aerosol inhalers or vaporisation devices are becoming increasingly popular consumer products.

Heating devices for vaporisation or aerosolisation are known in the art. Such devices typically include a heating chamber and heater. In operation, an operator inserts the product to be aerosolised or vaporised into the heating chamber. The product is then heated with an electronic heater to vaporise the constituents of the product for the operator to inhale. In some examples, the product is a tobacco product similar to a traditional cigarette. Such devices are sometimes referred to as “heat not burn” devices in that the product is heated to the point of aerosolisation, without being combusted.

Problems faced by known aerosol generation devices include providing effective power management, as well as improving usability.

### SUMMARY OF INVENTION

An object of the invention is to address providing effective power management, and improving usability, amongst others.

In a first aspect, there is provided an aerosol generation device comprising a holding unit configured to receive and aerosolise an aerosol generating substrate, and a charging unit that is connectable to the holding unit;
the holding unit comprising a heater component configured to aerosolise the aerosol generating substrate, a first charge storage module configured to power the heater component, and a cavity into which the aerosol generating substrate is insertable for heating with the heater component to generate an aerosol, wherein the cavity is configured to receive an aerosol generating substrate that is substantially planar in shape;
the charging unit comprising a second charge storage module configured to charge the first charge storage module and power the heater component;
the aerosol generation device further comprising a controller configured to:
when the holding unit is connected to the charging unit, pre-heat the heater component for an aerosolisation session by directing a power flow from the second charge storage module to the heater component.

A considerable amount of power can be required to pre-heat the heater component; this amount of power can significantly drain the charge level in the first charge storage module. By pre-heating the heater component when the holding unit is connected to the charging unit by directing a power flow from the second charge storage module to the heater component, a charge level in the first charge storage module can be preserved for a remainder of the aerosolisation session after the pre-heating. In this way, a smaller charge storage module can be included in the holding unit, improving usability and safety.

Configuring the cavity to receive an aerosol generating substrate that is substantially planar or flat in shape is advantageous in that a heater component and heating cavity are provided, combined with substantially planar aerosol generation substrate, that are very compact in physical size. This improves the usability of the device by delivering a holding unit that is smaller and more comfortable for the operator to hold.

However, the cavity with the heating component, configured to receive an aerosol generating substrate that is substantially planar in shape, can use considerably more power to heat than a traditional aerosol generation device that is configured to receive cigarette-like tubular substrates, this can particularly be the case during pre-heating.

The pre-heating power level can be too high for the first charge storage module to power alone. By powering the heating component using the second charge storage module during the pre-heating, a charge level in the first charge storage module can be preserved for the remainder of the aerosolisation session after the pre-heating. Then, for a heating phase in which the substrate is maintained at an aerosolisation temperature and the generated aerosol is inhaled by the operator, the holding unit can be disconnected from the charging unit and the preserved charge level in the first charge storage module can be used to power the heater. Advantageously, this allows for a rapid pre-heating of the heating component powered by the second charge storage module, whilst also maintaining a sufficient charge level in the first charge storage module for the heating phase. Moreover, this allows for a smaller size of holding unit to be used for the heating phase as a smaller battery can be utilised, thereby improving the comfort when the operator to brings the device to their mouth for aerosol inhalation. As such, in a synergistic manner, improved power usage is provided with improved usability.

Preferably, the aerosol generating substrate is an aerosol generating substrate that comprises tobacco. Preferably, the aerosol generating substrate is substantially planar in shape. Preferably, the aerosol generating substrate is in the cavity.

Preferably, the cavity comprises two major internal faces, wherein the two major internal faces oppose one another, the aerosol generating substrate is configured to be received between the opposing major internal faces, and the major internal faces are each associated with a heating element of the heater component.

In this way, the substantially planar or flat aerosol generating substrate can be sandwiched' between heating elements for a consistent overall heating and aerosolisation.

Preferably, the major internal faces are formed by two opposing walls of the cavity, wherein the walls comprise a ceramic material with heater wire embedded therein or thereon.

In this way, a compact heating cavity is provided, with well-distributed heat directed to the substrate.

Preferably, the cavity has two minor internal faces connecting the two major internal faces, wherein the two minor internal faces are smaller than the two major internal faces.

In this way, the dimensions of the cavity can be minimised to reduce the overall size of the holding unit of the aerosol generation device.

Preferably, the controller is configured to:
when the holding unit is connected to the charging unit, direct a power flow from the second charge storage module to the heater component to heat an aerosol generating substrate received in the holding unit in an aerosolisation session; and
when the holding unit is not connected to the charging unit, direct a power flow from the first charge storage module to the heater component to heat an aerosol generating substrate received in the holding unit in an aerosolisation session.

In this way, the charge level in the first charge storage module can be maintained for when the holding unit is disconnected from the charging unit, thereby helping to ensure that the first charge storage module has an adequate charge level for when the holding unit is disconnected from the charging unit. This improves the overall power management.

Preferably, the first charge storage module configured to power the heater component to aerosolise a first number of aerosol generating substrates, and the second charge storage module is configured to power the heater component to aerosolise a second number of aerosol generating substrates, wherein the second number of aerosol generating substrates is greater than the first number of aerosol generating substrates.

In this way, a physically smaller charge storage module can be included in the holding unit, for improved comfort and safety.

Preferably, the controller is further configured to:
when the holding unit is connected to the charging unit, direct a power flow from the second charge storage module to the first charge storage module to charge the first charge storage module.

In this way, the second charge storage module in the charging unit is used to recharge the first charge storage module in the holding unit to help ensure that the first charge storage module has an adequate charge level for when the holding unit is disconnected from the charging unit. This improves the overall power management.

Preferably, the holding unit is configured to be received within the charging unit when connected to charging unit.

In this way, a compact overall device is provided when the holding unit is connected to the charging unit, thereby improving the overall usability.

Preferably, the holding unit comprises a mouthpiece portion configured to be accessible for an operator to inhale upon when the holding unit is received within and connected to the charging unit.

In this way, the operator can perform an aerosolisation session with the holding unit and charging unit in connection, thereby improving the overall usability and power management.

Preferably, the mouthpiece portion comprises a mouthpiece that extends outward from the charging unit when the holding unit is received in the charging unit.

In this way, the operator can conformably access the mouthpiece for an aerosolisation session with the holding unit and charging unit in connection.

Preferably, the mouthpiece is removable for insertion of an aerosol generating substrate into the holding unit.

In this way, the aerosol generating substrate can be easily inserted to the holding unit, whilst maintaining the compact physical dimensions of the holding unit to improve the usability.

Preferably, the first charge storage module comprises at least one battery, supercapacitor or hybrid capacitor, and the second storage module comprises at least one battery, supercapacitor or hybrid capacitor.

In a second aspect, there is provided an aerosol generation system comprising the aerosol generation device of any preceding claim having an aerosol generating substrate received in the holding unit of the aerosol generation device.

In a third aspect, there is provided a method of operating an aerosol generation device, the aerosol generation device comprising:
a holding unit configured to receive and aerosolise an aerosol generating substrate, the holding unit comprising a heater component configured to aerosolise the aerosol generating substrate, a first charge storage module configured to power the heater component, and a cavity into which the aerosol generating substrate is insertable for heating with the heater component to generate an aerosol, wherein the cavity is configured to receive an aerosol generating substrate that is substantially planar in shape, and a charging unit that is connectable to the holding unit, the charging unit comprising a second charge storage module configured to charge the first charge storage module and power the heater component; and
wherein the method comprises:
determining that the holding unit is connected to the charging unit; and
pre-heating the heater component for an aerosolisation session by directing a power flow from the second charge storage module to the heater component when the holding unit is connected to the charging unit.

The method of the third aspect can include the preferable features of the aerosol generation device of the first aspect, as appropriate.

In a fourth aspect, there is provided a non-transitory computer-readable medium storing instructions executable by one or more processors of an aerosol generation device, the aerosol generation device comprising:
a holding unit configured to receive and aerosolise an aerosol generating substrate, the holding unit comprising a heater component configured to aerosolise the aerosol generating substrate, a first charge storage module configured to power the heater component, and a cavity into which the aerosol generating substrate is insertable for heating with the heater component to generate an aerosol, wherein the cavity is configured to receive an aerosol generating substrate that is substantially planar in shape, and a charging unit that is connectable to the holding unit, the charging unit comprising a second charge storage module configured to charge the first charge storage module and power the heater component; and
wherein the instructions cause the one or more processors to perform steps comprising:
determining that the holding unit is connected to the charging unit; and
pre-heating the heater component for an aerosolisation session by directing a power flow from the second charge storage module to the heater component when the holding unit is connected to the charging unit.

The non-transitory computer-readable medium of the fourth aspect can include the preferable features of the aerosol generation device of the first aspect, as appropriate.

### BRIEF DESCRIPTION OF THE DRAWINGS

Embodiments of the invention are now described, by way of example, with reference to the drawings, in which:

FIG. 1A is a diagram of an aerosol generation device comprising a handpiece and a charging unit, with the handpiece removed from the charging unit;

FIG. 1B is a diagram of an aerosol generation device comprising a handpiece and a charging unit, with the handpiece received in the charging unit;

FIG. 1C is a diagram of an aerosol generation device comprising a handpiece and a charging unit, with the handpiece pivotally connected to the charging unit;

FIG. 2 is a diagram of the handpiece of FIGS. 1A-C in more detail;

FIG. 3 is a diagram of an aerosol generating substrate configured for use with the handpiece of FIG. 2;

FIG. 4A is a diagram of a heating chamber of the handpiece 10 of FIG. 2 with the aerosol generating substrate of FIG. 3;

FIG. 4B is a diagram of the heating chamber of FIG. 4A in more detail;

FIG. 5 is a diagram of the mouthpiece portion of the handpiece of FIG. 2 in more detail;

FIG. 6 is an exemplary plot of average power delivered to a heater against time for an aerosolisation session; and

FIG. 7 is an operational flow chart of aerosolisation session.

### DETAILED DESCRIPTION

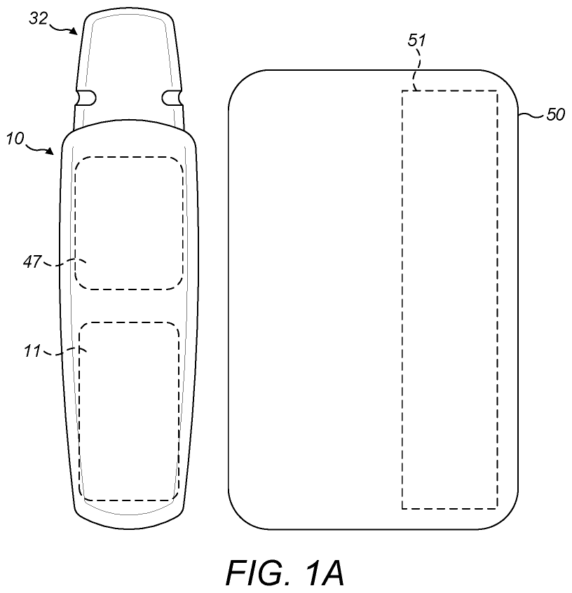

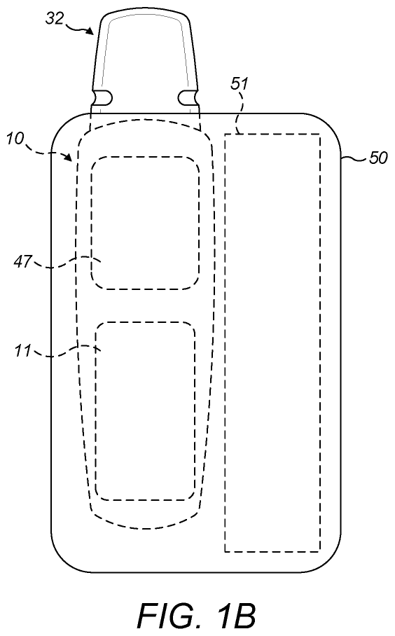

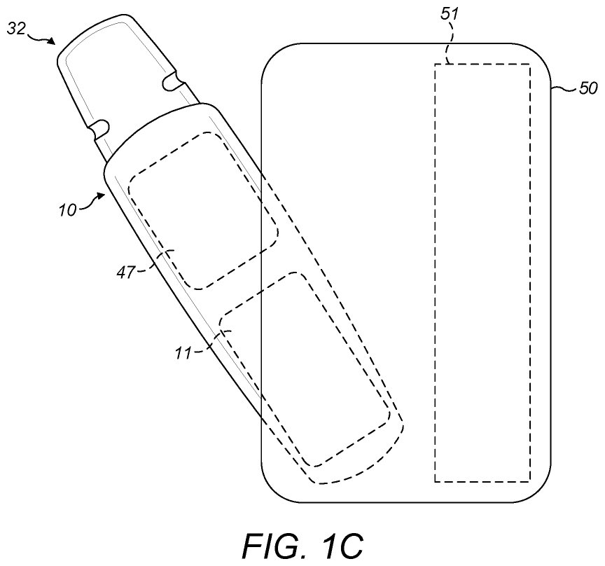

FIGS. 1A, 1B and 1C show various arrangements of an aerosol generation device (also known as a vapour generating device, vaping device, or electronic cigarette) comprising a handpiece 10 (also referred to as a holding unit) and a charging unit 50. The handpiece 10 is removably connectable to the charging unit 50.

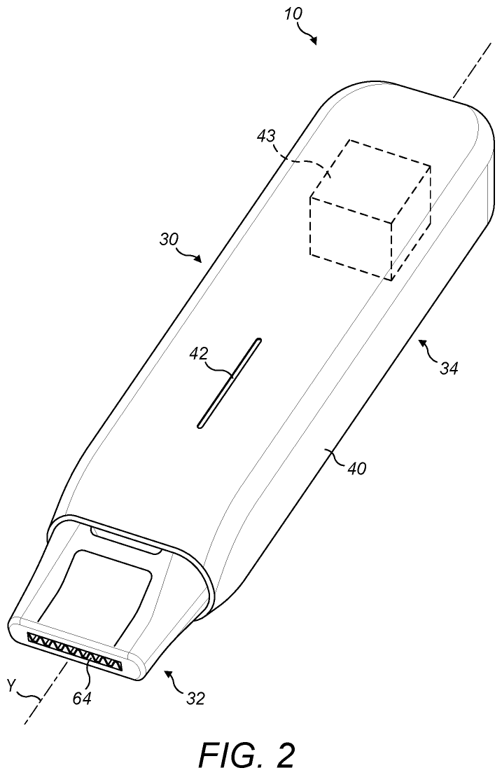

The handpiece 10 comprises a first charge storage module 11, and a heater 47 (also referred to as a heater component). The first charge storage module 11 is configured to power the heater 47 to aerosolise an aerosol generating substrate (not shown), as described in more detail with respect to FIGS. 2 to 5. The handpiece 10 also has a mouthpiece 32 upon which an operator inhales during an aerosolisation session to inhale the generated aerosol.

The charging unit 50 comprises a second charge storage module 51 that is configured to charge the first charge storage module 11 and power the heater 47.

The first charge storage module 11 can be one or more batteries or supercapacitors, or a combination thereof. The first charge storage module 11 can be a fast-charging battery, for example a battery with chemistry such as lithium titanate (LTO). Batteries of this type are able to deliver the high current required at the beginning of an aerosolisation session and have superior safety properties.

The second charge storage module 51 can be one or more batteries or supercapacitors, or a combination thereof. In an example, the second charge storage module 51 can be a single high energy density lithium-ion battery with moderate power capability. In another example, the second charge storage module 51 can be a combination of a high energy density lithium-ion battery with low power capabilities, and a high power battery (such as LTO, or lithium iron phosphate LFP) or a supercapacitor module.

In the following description, the first charge storage module is referred to as the handpiece battery 11, and the second charge storage module is referred to as the charging unit battery 51. However, the skilled person will readily understand that each of these can be one or more batteries, supercapacitors, or a combination thereof.

The charging unit battery 51 has a larger charge storage capacity than the handpiece battery 11. That is, the charging unit battery 51 can hold more charge the handpiece battery 11. The handpiece battery 11 may be capable of powering the heater 47 to aerosolise a first number of aerosol generating substrates, and the charging unit battery 51 may be capable of powering the heater 47 to aerosolise a second number of aerosol generating substrates, wherein the second number is greater than the first number. For example, the handpiece battery 11 may be capable of powering the heater 47 to aerosolise two aerosol generating substrates, and the charging unit battery 51 may be capable of powering the heater 47 to aerosolise twenty aerosol generating substrates.

In this way, the handpiece 10 can be dimensioned to be smaller than the charging unit 50 to be more comfortable for an operator to hold during an aerosolisation session. The larger charging unit 50 can then be used to charge the handpiece 10 between aerosolisation sessions. As such, there is a technical advantage in the provision of an aerosol generation device that has a smaller and more user-friendly handpiece 10 for aerosolisation sessions that can power a large number of sessions without needing to be connected to an external power source.

The charging unit 50 is dimensioned to receive and accommodate the handpiece 10 within an opening in the charging unit 50. The charging unit battery 51 connects by connectors in the charging unit opening to corresponding connectors in the handpiece 10 when the handpiece is received in the charging unit 50. A controller in the handpiece 10 or the charging unit 50 can detect a signal between the handpiece connectors and the charging unit connectors and control a power flow from the charging unit battery 51 to the handpiece battery 11. A power flow as discussed herein can be considered as a flow of electric charge, or a current, from one element to another. In this way, when the operator inserts the handpiece 10 into the charging unit 50, the handpiece battery 11 and charging unit battery 51 are brought into connection so that the handpiece battery 11 can be charged by the charging unit battery 51 through the connection between the connectors. As such, the charging unit 50 can be considered as a charging case for the handpiece 10. Likewise, power can flow from the charging unit battery 51 to the heater 47 by the connectors, to power the heater 47 using the charging unit battery 51.

The charging unit battery 51 can store enough charge to fully recharge the handpiece battery 11 a plurality of times. The charging unit battery 51 can itself be charged from an external power source, such as a power bank or mains source, by a connection such as a USB cable, or through connection to a docking station.

FIG. 1A shows the handpiece 10 removed from the charging unit 50 so that they are not in connection with one another. FIG. 1B shows the handpiece 10 received in and connected to the charging unit 50. In the example of FIG. 1B, the mouthpiece 32 of the handpiece 10 extends outwardly from the charging unit 50. In this way, the operator can perform an aerosolisation session whilst the handpiece 10 is housed within the charging unit 50.

Alternatively or additionally, in some examples, the charging unit 50 and handpiece 10 can be configured so that the handpiece 10 can pivot outwardly from the charging unit 50, whilst still connected to the charging unit 50, by a hinged connection at the end of the handpiece 10 away from the mouthpiece 32, as shown in FIG. 1C. This can provide greater access to the handpiece 10 whilst still connected to the charging unit 50.

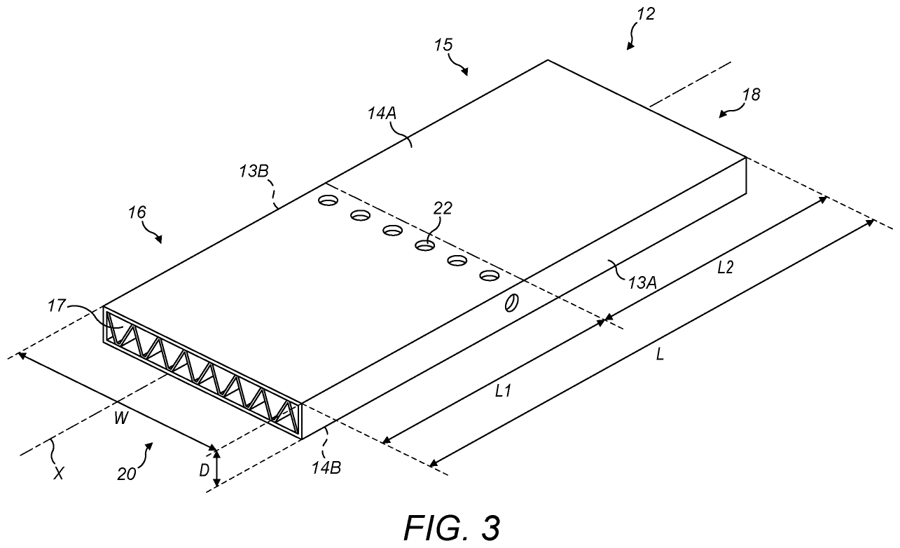

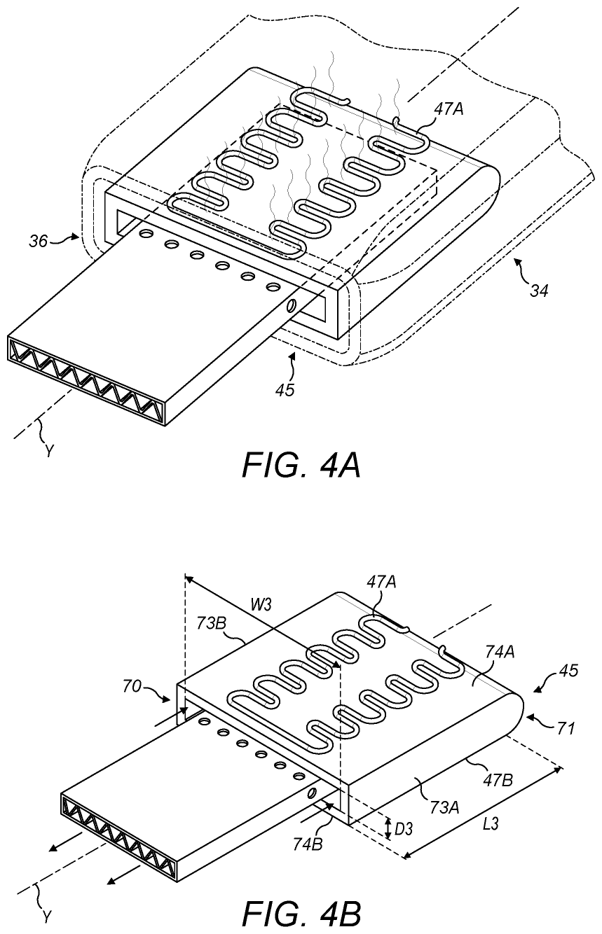

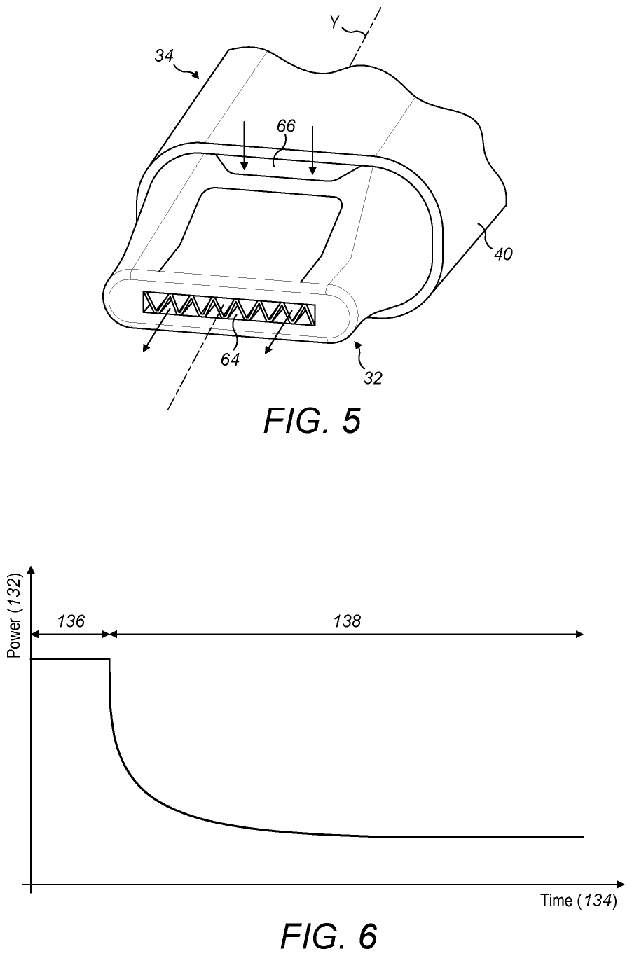

FIGS. 2 to 5 show the handpiece 10 in more detail. FIG. 2 shows the handpiece 10 with the connected mouthpiece portion 32. FIG. 3 shows an aerosol generating substrate 12 configured for use with the handpiece 10 of FIG. 2. FIG. 4A shows a heating chamber 45 of the handpiece 10 of FIG. 2 with the aerosol generating substrate 12 of FIG. 3, and FIG. 4B shows the heating chamber 45 in more detail. FIG. 5 shows the mouthpiece portion 32 of the handpiece 10 of FIG. 2 in more detail.

The aerosol generating substrate 12 is planar or flat in shape, for example in the form of flat-shaped cuboid extending along a substrate axis X and having external dimensions LxWxD. In a specific example, the length L of the substrate according to the substrate axis X equals substantially to 33 mm, width W and depth D are substantially 12 mm and 1.2 mm, respectively. That is to say, the substrate can be considered planar in shape in that it has a depth that is much shorter than the length and width.

The depth D of the substrate 12 is formed by a pair of parallel walls 13A, 13B, referred to as substrate lateral walls 13A, 13B. The width W of the substrate is formed by a pair of parallel walls 14A, 14B, referred to as substrate contact walls 14A, 14B. In other examples, the aerosol generating substrate 12 can be of other suitable shapes or dimensions. For example, the aerosol generating substrate be in of a circular tube shape, similar to a traditional cigarette.

The aerosol generating substrate 12 can comprise a heating portion 15 and a mouthpiece part 16 arranged along the substrate axis X. However, in some examples, the aerosol generating substrate 12 may comprise only the heating portion 15. The mouthpiece part has a length L1, and the heating part has a length L2. In some examples, the heating portion 15 can be slightly longer than the mouthpiece part 16, that is, L2 can be greater than L1. The heating portion 15 defines an abutting end 18 of the substrate 12 and the mouthpiece part 16 defines a mouth end 20 of the substrate 12. The heating portion 15 and the mouthpiece part 16 may be connected by a wrapper extending around the substrate axis X. Alternatively, the parts 15, 16 may be wrapped by different wrappers and fixed one to the other by any other suitable mean. The wrapper(s) can comprise paper and/or non-woven fabric and/or aluminium. The wrapper(s) may be porous or air impermeable. The wrapper(s) can form a plurality of airflow channels extending inside the substrate 12 between the abutting end 18 and the mouth end 20.

The heating portion 14 is configured to be heated by a heater and comprises an aerosol generating material. The aerosol generating material can be a material that may for example comprise nicotine or tobacco and an aerosol former. Tobacco may take the form of various materials such as shredded tobacco, granulated tobacco, tobacco leaf and/or reconstituted tobacco. Suitable aerosol formers include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some embodiments, the aerosol generating agent may be glycerol, propylene glycol, or a mixture of glycerol and propylene glycol. The substrate may also comprise at least one of a gelling agent, a binding agent, a stabilizing agent, and a humectant. When the aerosol generating material is heated, an aerosol or vapour is formed. It will be understood that the terms aerosol and vapour can be used interchangeably in this description. In an example, the aerosol generating material forms an aerosol when it is heated by the heater 47 without being burned.

The mouthpiece part 16 is intended to be received inside a mouthpiece 32. The mouthpiece part 16 comprises a core 17 that can provide a filtering functionality.

In some examples, the core 17 can be a foam, or packed strands of fibres. The core 17 can be formed through an extrusion and/or rolling process into a stable shape. The substrate 12 may be shaped to provide one or more airflow channels. As shown in the example of FIG. 3, the mouthpiece part 16 defines a plurality of venting holes 22 arranged on walls of the substrate, and this can include one of more of the substrate lateral walls 13A, 13B and the substrate contact walls 14A, 14B. The venting holes 22 allow fresh air entering inside the substrate 12 to achieve particular vaping/tasting effects.

The handpiece 10 comprises a handpiece body 30 extending along a handpiece axis Y and forming at least one side wall 40 of the handpiece 10. The handpiece body 30 comprises a mouthpiece 32 and a housing 34 arranged successively according to the handpiece axis Y. In the example of FIG. 1, the mouthpiece 32 and the housing 34 form two different pieces. The mouthpiece 32 is designed to be removably fixed on, or received in, an insertion opening 36 formed at one of the ends of the housing 34. This opening 36 extends perpendicularly to the handpiece axis Y as it is shown on FIG. 4 where the mouthpiece 32 is removed from the housing 34.

In each cross section, the housing 34 may for example form a substantially rectangular shape with rounded edges, with at least four side walls 40. In other examples, the housing may have at least one different cross-sectional shape, for example a round shape. The housing 34 can be sealed at the end opposite to the insertion opening 36 receiving the mouthpiece 32. The housing 34 can be formed from a single piece or several assembled pieces made of any suitable material like aluminium or plastic. One or more side walls 40 of the housing can have one or more openings for control and/or visual elements. For example, such elements can include one or more of control buttons, touch panels, screens, LEDs, etc. In an example, the housing 34 has a slot 42 for an LED indicating at least an ON state of the handpiece 10. In some examples, the LED can also indicate status information of the handpiece such as a battery state, an error state, etc.

The housing 34 contains the handpiece battery (not shown) for powering the handpiece 10, a controller 43 for controlling the operation of the handpiece 10, a heating chamber (also referred to as a heating cavity) 45 for heating the aerosol generating substrate 12 and at least two heating elements 47A, 47B for heating the heating chamber 45.

The mouthpiece 32 is configured to connect to the insertion opening 36 while assembling the mouthpiece 32 with the housing 34

The mouthpiece 32 has a through-hole along the handpiece axis Y designed to receive the mouthpiece part 16 of the aerosol generating substrate 12 so that the substrate axis X coincides with the handpiece axis Y. The through-hole can have the same cross-sectional shape as the aerosol generating substrate 12 with internal dimensions slightly greater than the external dimensions of the mouthpiece part 16 of the aerosol generating substrate 12. In an example, the through-hole defines a rectangular cross-section for receiving the mouthpiece part 16 of the aerosol generating substrate 12.

The mouthpiece 32 can have a recessed portion so that when the mouthpiece 32 is inserted in the insertion opening 36, the recess portion forms an opening 66 forming a flow inlet 66. Where the aerosol generating substrate 12 comprises the venting holes 22, at least some of these venting holes 22 are arranged to face the flow inlet 66.

Turning to FIGS. 4A and 4B in more detail, the heating chamber 45 can be cup-shaped and extend along the handpiece axis Y between an open end 70 into which the aerosol generating substrate 12 is inserted, and an opposing sealed end 71. The heating chamber 45 receives the heating portion 15 of the aerosol generating substrate 12. The heating chamber 45 has substantially the same cross-sectional shape as the aerosol generating substrate 12. In an example, the heating chamber 45 defines a rectangular cross-sectional shape with two parallel chamber lateral walls 73A, 73B and two parallel chamber contact walls 74A, 74B. The walls 74A, 74B form two major internal faces in the chamber 45, and oppose one another; the aerosol generating substrate is configured to be received between these opposing major internal faces. The major internal faces each comprise a heating element 47A, 47B of the heater component 47. The walls 73A, 73B form two minor internal faces of the chamber, connecting the two major internal faces. The two minor internal faces are smaller than the two major internal faces, and the cavity is configured to receive an aerosol generating substrate that is substantially planar in shape. Each chamber wall 74A, 74B is for example at least 3 times, advantageously 5 times and more advantageously 8 times, wider than each chamber wall 73A, 73B.

The heating chamber 45 has a distal wall arranged perpendicularly to the handpiece axis Y and sealing the sealed end 71. The distal wall is adjacent to each of the walls 73A, 73B, 74A, 74B to seal the chamber at the sealed end 71 and form a cup shape of the chamber. Each of the walls 73A, 73B, 74A, 74B, 75 can be of a thermally conductive material, such as a metal, notably a stainless steel. Additionally, at least some of the walls 73A, 73B, 74A, 74B, 75 or all of these walls can form one single piece. Alternatively, the walls 74A, 74B can be ceramic with heater wires or tracks embedded therein or thereon. The walls 73A, 73B and 75 can also be ceramic.

The internal dimensions of the heating chamber 45 are defined by the length L3 measured according the handpiece axis Y, the width W3 measured as the distance between the chamber lateral walls 73A, 73B and the depth D3 measured as the distance between the chamber contact walls 74A, 74B. These internal dimensions L3, W3, D3 are chosen basing on the external dimensions L2, W, D of the heating portion 15 of the aerosol generating substrate 12.

The depth D3 of the heating chamber 45 can be slightly greater than the depth D of the aerosol generating substrate 12 or substantially equal to this depth D. In this case, the substrate contact walls 14A, 14B can be in contact with the chamber contact walls 74A, 74B and notably with contact surfaces of these walls 74A, 74B, when the heating portion 15 of the of the aerosol generating substrate 12 is received inside the heating chamber 45. Advantageously, in this case, the chamber contact walls 74A, 74B and notably their contact surfaces, are in a tight contact with the substrate contact walls 14A, 14B. In other examples, the depth D3 of the heating chamber 45 can be slightly less than the normal depth D of the aerosol generating substrate 12. In this case, the heating chamber 45 and/or the mouthpiece 32 is (are) configured to compress the heating portion 15 of the aerosol generating substrate 12 by exerting force on the substrate contact walls 14A, 14B. This makes it possible to improve the tight contact between the corresponding contact walls of the heating chamber 45 and the substrate 12 and thus, to improve heat transfer between these walls.

The width W3 of the heating chamber 45 can be defined so as at least one pair of facing lateral walls 73A, 13A or 73B, 13B of the heating chamber 45 and the aerosol generating substrate 12 forms an airflow channel between them. When the heating portion 15 of the aerosol generating substrate 12 is inserted in the heating chamber 45, an airflow channel is formed along the handpiece axis Y on either lateral side of the aerosol generating substrate 12. In an alternative, no airflow channel between the pairs of facing lateral walls 73A, 13A or 73B, 13B of the heating chamber 45 and the aerosol generating substrate 12 is formed. Instead, the pairs of lateral walls 73A, 13A or 73B, 13B may be in contact. This is suitable when the distal wall 75 or any other wall of the heating chamber 45 forms an opening suitable for air entering.

The walls 74A and 74B of the chamber 45 each have a heating element 47A, 47B. The heating elements 47A, 47B form the heater 47 (also referred to as a heater component) of the device. In an example, the heating elements 47A, 47B can be arranged in contact with one of the chamber contact walls 74A, 74B outside of the heating chamber 45. In the example of FIG. 4B, the heating element 47A is arranged adjacent to an outer surface of the chamber contact wall 74A and the heating element 47B is arranged adjacent to an outer surface of the chamber contact wall 47A. Thus, the chamber contact walls transfer heat from the heating elements 47A, 47B to the aerosol generating substrate 12. Each heating element 47A, 47B may comprise a polyimide film heater extending along substantially the total area of said outer surface of the corresponding heating wall 74A, 74B or only along a part of this surface. In other examples, the heating elements can be embedded within the chamber walls. For example, the heating element 47A can be embedded in the chamber contact wall 74A, and the heating element 47B can be embedded in the chamber contact wall 74B. In a further example, the heating elements can be on the chamber walls, internal to the heating chamber 45.

Optionally, the handpiece 10 can also include an insulator arranged between each heating element 47A, 47B and an inner surface of the housing 34. The same insulator may also be arranged between an outer surface of each of the chamber lateral walls 73A, 73B and the inner surface of the housing 34.

The handpiece 10 comprises a controller 43. The controller 43 is configured to control the operation of the handpiece 10. This can include inhibiting and enabling the operation of the device, as well as controlling a power flow of the handpiece battery 11 based upon an operating mode of the handpiece 10.

The controller 43 can be at least one microcontroller unit comprising memory, with instructions stored thereon for operating the handpiece 10, including instructions for inhibiting and enabling the operation of the device, instructions for executing operating modes of the device, instructions for controlling the power flow from the battery, and the like, and one or processors configured to execute the instructions.

The controller 43 may be configured to operate separately the operation of each heating element 47A, 47B, according to a heating profile chosen among a predetermined group of heating profiles. The corresponding heating profile may be chosen according to a mode of operation of the handpiece 10 and/or according to at least some external/internal parameters relative to the operation of the handpiece 10.

The controller 43 controls a power flow to the heater 47 in the aerosolisation session, wherein an aerosolisation session can include a pre-heating phase and a heating phase.

In the pre-heating phase, the heater 47 is heated to a predetermined temperature for the generation of an aerosol from the aerosol generating substrate 12. The pre-heating phase can be considered the time during which a pre-heating mode is being executed, for example the time it takes for the heater 47 to reach the predetermined temperature. The pre-heating mode occurs during a first time period of the aerosolisation session. In an example, the first time period can be a fixed pre-determined time period. In other examples, the first time period can vary corresponding to the length of time needed to heat the heater 47 to the predetermined temperature. The predetermined temperature can be stored in memory accessible by the controller.

When the pre-heating phase is complete, the controller 43 ends the pre-heating mode and controls a power flow to the heater 47 to power the heating phase. In the heating phase, the controller 43 controls the power flow to the heater 47 to maintain the heater 47 substantially at the predetermined temperature so that an aerosol is generated for the consumer to inhale. A heating phase can be considered the time during which a heating mode is being executed, for example the time during which the heater 47 is aerosolising one (or at least part of one) aerosol generating substrate 12 after the pre-heating phase. The controller 43 can control the power flow to the heater 47 in the heating mode for a second time period of the aerosolisation session. The second time period can be predetermined and stored at the controller 43.

FIG. 6 shows an exemplary plot of average power 132 delivered to the heater 47 against time 134 for an aerosolisation session. In the pre-heating phase, the controller 43 controls the power flow to the heater 47 to apply power to the heater 47 for the first time period 136, until the heater 47 temperature reaches the predetermined temperature. In an example, the predetermined temperature may be 230° C. In an example, the first time period is 20 seconds. In some examples, the controller 43 is configured to heat the heater 47 to the predetermined temperature within a fixed predetermined first time period. In other examples, the first time period varies depending on how long the heater 47 takes to reach the predetermined temperature.

When the heater 47 reaches the predetermined temperature, the controller 43 switches the operating mode to the heating phase for the second time period 138 and maintains the heater 47 temperature substantially at the predetermined temperature for this second time period 138. In an example, the second time period may be 250 seconds. Typically, a lower power level is applied to the heater 47 in the heating phase when maintaining the heater 47 at the predetermined temperature, than the power level applied to the heater 47 to heat it to the predetermined temperature in the pre-heating phase. This can be seen in FIG. 6 in that the power delivered to the heater 47 in the second time period 138 is lower than the power delivered to the heater 47 in the first time period 136. The power level delivered to the heater 47 can be controlled by various means, for example adjusting the power output from the battery/batteries, or by adjusting the on/off periods in a pulse width modulated power flow.

Following the aerosolisation session the user of handpiece 10 may be informed that the aerosolisation session has ended, by way of a visual, haptic or audible indicator for example, so that they are aware that the substrate is no longer being aerosolised.

The arrangement of the heating chamber 45 and heater 47, in combination with the aerosol generating substrate 12, as described in detail with reference to FIGS. 2 to 5 is advantageous in that the heater 47 is very compact, and allows for the aerosol generating substrate 12 to be planar in shape with compact dimensions. This therefore reduces the overall size of the aerosol generation device and consumable compared to an aerosol generation device that is configured to receive a more traditional cigarette or cigarette-like consumable (sometimes referred to as a tobacco rod). However, the heater 47 of the example described in detail with reference to FIGS. 2 to 5, particularly when including a ceramic heater, can require considerably more power to heat (e.g. »10 W and/or »1600 J) than the heater of an aerosol generation device that is configured to receive a more traditional cigarette or cigarette-like consumable. This is particularly the case in the pre-heating phase where a higher power flow to the heater is required. As explained above, a higher power level is applied to the heater 47 during the pre-heating phase of the aerosolisation session. This power level can be too high for the battery in the handpiece 10 to power alone. As such, for the pre-heating phase, the handpiece 10 and the charging unit 50 can be connected.

For example, a battery current of e.g. 8 A for pre-heating is a big challenge for the battery in the handpiece, if we refer it to its capacity. This means a 200 mAh battery would have to be able to provide 40 C discharge rate (8 A/0.2 Ah). This is very high in the lithium-ion battery space. However, for a bigger battery in the charger unit, e.g. 2000 mAh, this rate is just 4 C. This is allows for a smaller size of the handpiece to be achieved the handpiece battery does not need to be oversized to fulfil the power requirements.

In this way, the larger/more powerful battery in the charging unit 50 can be used to power the heater 47 for the pre-heating phase alone or in combination with the smaller battery in the handpiece 10. Then, for the heating phase, the handpiece 10 can be removed from the charging unit 50 for the heating phase. Advantageously, and in a synergistic manner, this allows the heater 47 to be pre-heated rapidly, whilst also maintaining a sufficient battery level in the handpiece 10 for the heating phase to be carried out disconnected from the charging unit. Moreover, a smaller size of handpiece can be used for the heating phase, to improve the comfort when the consumer to brings the device to their mouth for aerosol inhalation.

In some examples, the heating phase can also be carried out with the handpiece 10 and charging unit 50 in connection with one another. For example, this could take place if the handpiece battery is not sufficiently charged for the heating phase at the end of the pre-heating phase, advantageously allowing the consumer to perform an aerosolisation session when the handpiece has a low battery level rather than waiting for it to charge.

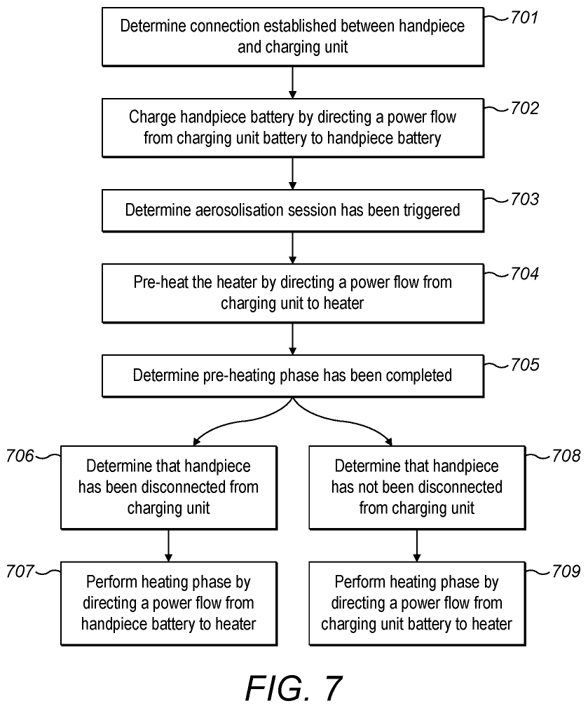

FIG. 7 shows an operational flow chart relating to the control of an aerosolisation session of, for example, the aerosol generation device of FIGS. 1 to 5.

At step 701, when the handpiece 10 is connected to the charging unit 50, a controller of the aerosol generation device determines that the connection has been established. In this step, the controller may be the controller 43 of the handpiece 10 and/or a controller in the charging unit 50.

At step 702, the controller controls the charging unit battery to direct a power flow to the handpiece battery, by the connectors between the handpiece and the charging unit. In this way, the charging unit battery is used to charge the handpiece battery. In this step, the controller may be the controller 43 of the handpiece 10 and/or a controller in the charging unit 50.

At step 703, the controller determines whether an aerosolisation session has been triggered. In some examples, the controller may determine that an aerosolisation session has been triggered in response to a user input, for example the triggering of a button on the aerosol generation device that a user can press or operate to begin an aerosolisation session. In this step, the controller may be the controller 43 of the handpiece 10 and/or a controller in the charging unit 50.

At step 704, the controller is configured to pre-heat the heater component for an aerosolisation session by directing a power flow from the charging unit battery 51 to the heater component 47. This can take place in response to the controller determining that an aerosolisation session has been triggered. In this step, the controller may be the controller 43 of the handpiece 10 and/or a controller in the charging unit 50. In this way, the charging unit battery 51 can power the pre-heating phase so that the smaller handpiece battery 11 has a sufficient charge level for the heating phase.

Alternatively or additionally, the controller can control power flows from both the charging unit battery 51 to the heater component 47 and the handpiece battery 11 to the heater component 47 for the pre-heating. In this way, the charging unit battery 51 can supplement the smaller handpiece battery 11 (or the handpiece battery 11 could supplement the charging unit battery) for the pre-heating phase so that the handpiece battery 11 still has a sufficient charge level for the heating phase. For example, the handpiece battery 11 could support the charging unit battery 51 by delivering its maximum current (e.g. 1 A). At the same time, the current delivered by charging unit battery 51 could be significantly higher than that delivered by the handpiece battery 11 (e.g. 5 times higher).

As already described, because the handpiece battery 11 alone cannot provide sufficient power to pre-heat the heater component 47, the handpiece 10 must be connected to the charging unit 50 for the pre-heating phase. As such, the controller 43 of the handpiece 10 can determine whether the handpiece 10 is connected to the charging unit by detecting a signal between the connectors of the handpiece and the charging unit. When the handpiece 10 and the charging unit 50 are not in connection, the controller 43 can inhibit a power flow to the heater component 47 for the pre-heating phase to avoid over-working and potentially damaging the handpiece battery 11, and to prevent the handpiece battery 11 being drained of charge before the heating phase. When the handpiece 10 and charging unit 50 are in connection, the controller can permit the power flow to the heater component 47 for the pre-heating phase.

At step 705, the controller is configured to determine that the pre-heating phase has been completed. In some examples, the pre-heating phase may be determined to be completed when the controller determines that a predetermined pre-heating time period, stored in memory accessible by the controller, has expired. In other examples, the pre-heating phase may be determined to be completed when the controller determines that a predetermined heater temperature, stored in memory accessible by the controller, has been reached by monitoring a temperature associated with the heater using a temperature sensor. In this step, the controller may be the controller 43 of the handpiece 10 and/or a controller in the charging unit 50.

Following the pre-heating phase, the process continues to step 706 when the handpiece 10 has been separated from the charging unit 50 for the heating phase, or to step 708 when the handpiece has not been separated from the charging unit 50 for the heating phase.

At step 706, the controller 43 of the handpiece determines that the handpiece 10 has been disconnected from the charging unit 50. In an example, the controller 43 determines that the handpiece 10 and charging unit 50 have been disconnected by determining that there is no signal between the connectors of the two units.

In response to determining that the handpiece 10 has been disconnected from the charging unit 50, at step 707, the controller 43 controls the handpiece 10 to perform the heating phase by directing a power flow from handpiece battery 11 to heater 47. The controller 43 of the handpiece 10 directs a power flow from the handpiece battery 11 to the heater 47 to heat the aerosol generating substrate, in the heating phase, to generate an aerosol for the user to inhale.

In some examples, the handpiece controller 43 can monitor the charge level of the handpiece battery 11 and control an indicator (such as a visual, audible or haptic indicator) in the handpiece 10 or charging unit 50 to output a first indication when the handpiece battery 11 does not have sufficient charge to power a heating phase alone, and/or a different second indication when the handpiece battery 11 does have sufficient charge to power a heating phase alone. In this way, the user can be made aware that the two units cannot/can be disconnected for the heating phase.

At step 708, the controller 43 of the handpiece 10, and/or a controller of the charging unit 50, determines that the handpiece 10 has not been disconnected from the charging unit 50. That is, the controller 43 of the handpiece 10, and/or a controller of the charging unit 50, determines that the handpiece 10 and the charging unit 50 are still in connection with one another. In an example, the controller 43 of the handpiece 10, or the controller of the charging unit 50, determines that the handpiece 10 and charging unit 50 are connected by determining that there is a signal between the connectors of the two units.

The controller of the charging unit can be at least one microcontroller unit arranged in the charging unit and comprising memory, with instructions stored thereon for operating the charging unit in the manners described herein.

In response to determining that the handpiece 10 is connected to the charging unit 50, at step 709, the controller 43 of the handpiece 10, and/or a controller of the charging unit 50, controls the handpiece 10 and charging unit 50 to perform the heating phase by directing a power flow from charging unit battery to heater.

That is, the controller 43 of the handpiece 10, and/or a controller of the charging unit 50 directs a power flow from the charging unit battery 51 to the heater 47 to heat the aerosol generating substrate, in the heating phase, to generate an aerosol for the user to inhale.

Alternatively or additionally, the controller 43 of the handpiece 10, and/or a controller of the charging unit 50 can direct a power flow from both the charging unit battery 51 and the handpiece battery 11 to the heater 47 to heat the aerosol generating substrate, in the heating phase, to generate an aerosol for the user to inhale. In this way, the smaller handpiece battery 11 can supplement charging unit battery 51 for the heating phase; this can be useful if, for example, the charging unit battery 51 does not have a sufficient charge level to complete the aerosolisation session,

In some examples, the heating phase may begin with the handpiece 10 connected to the charging unit 50, with the handpiece 10 and charging unit 50 then disconnected during the heating phase. In such an example, the controller 43 in the handpiece 10 can continually monitor the connection status to the charging unit 50; when the handpiece 10 and charging unit 50 are disconnected, the controller 43 can adjust the power flow to the heater 47 so that it is entirely powered by the handpiece battery 11 and the heating phase can continue.

When the handpiece 10 is connected to the charging unit 50, the controller 43 of the handpiece and/or a controller of the charging unit can control a power flow from the charging unit battery 51 to the handpiece battery 11, to charge the handpiece battery 11. This can occur when an aerosolisation session is not happening, and/or during an aerosolisation session when the two units are connected, for example during the pre-heating phase or the heating phase. In this way, the charge level in the handpiece battery is maintained so that charge is readily available should the operator wish to detach the handpiece 10 from the charging unit 50 for the heating phase of an aerosolisation session.

The operation of an exemplary aerosolisation session, with the aerosol generation device described with reference to FIGS. 1 to 5 will now be described.

To begin with, it is considered that the handpiece 10 is received in and connected to the charging unit (as described with reference to steps 701 and 702 of FIG. 7).

Initially, it is considered that the aerosol generating substrate 12 is extracted from the handpiece 10. In order to insert it, the user first takes off the mouthpiece 32 from the housing 34. Then, the user inserts the heating portion 15 of the aerosol generating substrate 12 into the heating chamber 45 until the abutting end 18 of the substrate 12 abuts against the stopping mean of the distal wall 75. Then, the user fixes the mouthpiece 32 on the housing 34 by sliding the mouthpiece part 16 of the aerosol generating substrate 12 inside the through-hole of the mouthpiece 32 and by inserting the mouthpiece 32 in the insertion opening 36 of the housing 34.

The user can activate the operation of the handpiece 10 by actuating for example an ON button (as described with reference to step 703 of FIG. 7). Upon activation of the handpiece 10, the controller 43 starts the pre-heating mode (as described with reference to step 704 of FIG. 7).

When it is determined that the pre-heating phase is complete (as described with reference to step 705 of FIG. 7), the controller 43 proceeds with the heating phase, as described with reference to steps 706 and 707 when the handpiece 10 is disconnected from the charging unit 50, or steps 708 and 709 when the handpiece 10 is connected to the charging unit 50.

In the heating mode, the user can inhale upon the mouthpiece. This creates an airflow in an airflow path formed inside the device between the flow inlet 66 and the flow outlet 64, as shown in FIG. 5. This airflow passes through the flow inlet 66 and into the venting holes 22. Here, it mixes with the aerosol that has been generated by heating the aerosol generating material in the heating portion 15 of the substrate 12. Another airflow path can be alternatively or additionally be provided through an opening in the body 34, and wall(s) of the heating chamber, and along the channel between the substrate 12 and the sidewalls of the heating chamber to the venting holes 22 of the substrate. The airflow is then drawn through mouthpiece part 16 of the substrate 12, out of the mouth end 20, and out of mouthpiece 32 by the flow outlet 64 of the mouthpiece 32. In this way, the operator can inhale the generated aerosol during the heating mode.

Following the aerosolisation session, the operator may reconnect the handpiece 10 to the charging unit 50 (if disconnected for the heating phase), to recharge the handpiece battery 11 from the charging unit battery 51.

In some examples, if the operator wishes to aerosolise a second aerosol generating substrate, shortly or immediately after the first aerosol generating substrate, the entire aerosolisation session (i.e. both the pre-heating phase and the heating phase) will have to take place with the handpiece 10 connected to the charging unit 50 if the handpiece battery 11 has not had sufficient time to recharge from the charging unit battery 51 before the second aerosolisation session.

The processing steps described herein carried out by the controller 43 of the handpiece, or the controller of the charging unit, may be stored in a non-transitory computer-readable medium, or storage, associated with the respective controller. A computer-readable medium can include non-volatile media and volatile media. Volatile media can include semiconductor memories and dynamic memories, amongst others. Non-volatile media can include optical disks and magnetic disks, amongst others.

It will be readily understood to the skilled person that the preceding embodiments in the foregoing description are not limiting; features of each embodiment may be incorporated into the other embodiments as appropriate.

1. An aerosol generation device comprising a holding unit configured to receive and aerosolise an aerosol generating substrate, and a charging unit that is connectable to the holding unit;
the holding unit comprising a heater component configured to aerosolise the aerosol generating substrate, a first charge storage module configured to power the heater component, and a cavity into which the aerosol generating substrate is insertable for heating with the heater component to generate an aerosol;
the charging unit comprising a second charge storage module configured to charge the first charge storage module and power the heater component;
the aerosol generation device further comprising a controller configured to:
when the holding unit is connected to the charging unit, pre-heat the heater component for an aerosolisation session by directing a power flow from the second charge storage module to the heater component.

2. The aerosol generation device of claim 1, wherein the cavity comprises two major internal faces, wherein the two major internal faces oppose one another, the cavity is configured to receive the aerosol generating substrate between the major internal faces, and the major internal faces are each associated with a heating element of the heater component.

3. The aerosol generation device of claim 2, wherein the major internal faces are formed by two opposing walls of the cavity, wherein the walls comprise a ceramic material with heater wire embedded therein or thereon.

4. The aerosol generation device of claim 2, wherein the cavity has two minor internal faces connecting the two major internal faces, wherein the two minor internal faces are smaller than the two major internal faces.

5. The aerosol generation device of claim 1, wherein the controller is configured to:
when the holding unit is connected to the charging unit, direct a power flow from the second charge storage module to the heater component to heat an aerosol generating substrate received in the holding unit in an aerosolisation session; and
when the holding unit is not connected to the charging unit, direct a power flow from the first charge storage module to the heater component to heat an aerosol generating substrate received in the holding unit in an aerosolisation session.

6. The aerosol generation device of claim 1, wherein the first charge storage module is configured to power the heater component to aerosolise a first number of aerosol generating substrates, and the second charge storage module is configured to power the heater component to aerosolise a second number of aerosol generating substrates, wherein the second number of aerosol generating substrates is greater than the first number of aerosol generating substrates.

7. The aerosol generation device of claim 1, wherein the controller is further configured to:
when the holding unit is connected to the charging unit, direct a power flow from the second charge storage module to the first charge storage module to charge the first charge storage module.

8. The aerosol generation device of claim 1, wherein the holding unit is configured to be received within the charging unit when connected to charging unit.

9. The aerosol generation device of claim 1, wherein the holding unit comprises a mouthpiece portion configured to be accessible for an operator to inhale upon when the holding unit is received within and connected to the charging unit.

10. The aerosol generation device of claim 9, wherein the mouthpiece portion comprises a mouthpiece that extends outward from the charging unit when the holding unit is received in the charging unit.

11. The aerosol generation device of claim 10, wherein the mouthpiece is removable for insertion of an aerosol generating substrate into the holding unit.

12. The aerosol generation device of claim 1, wherein the first charge storage module comprises at least one battery, supercapacitor or hybrid capacitor, and the second charge storage module comprises at least one battery, supercapacitor or hybrid capacitor.

13. An aerosol generation system comprising the aerosol generation device of claim 1 having an aerosol generating substrate received in the holding unit of the aerosol generation device.

14. A method of operating an aerosol generation device, the aerosol generation device comprising:
a holding unit configured to receive and aerosolise an aerosol generating substrate, the holding unit comprising a heater component configured to aerosolise the aerosol generating substrate, a first charge storage module configured to power the heater component, and a cavity into which the aerosol generating substrate is insertable for heating with the heater component to generate an aerosol, and a charging unit that is connectable to the holding unit, the charging unit comprising a second charge storage module configured to charge the first charge storage module and power the heater component; and
wherein the method comprises:
determining that the holding unit is connected to the charging unit; and
pre-heating the heater component for an aerosolisation session by directing a power flow from the second charge storage module to the heater component when the holding unit is connected to the charging unit.

15. A non-transitory computer-readable medium storing instructions executable by one or more processors of an aerosol generation device, the aerosol generation device comprising:
a holding unit configured to receive and aerosolise an aerosol generating substrate, the holding unit comprising a heater component configured to aerosolise the aerosol generating substrate, a first charge storage module configured to power the heater component, and a cavity into which the aerosol generating substrate is insertable for heating with the heater component to generate an aerosol, wherein the cavity is configured to receive an aerosol generating substrate that is substantially planar in shape, and a charging unit that is connectable to the holding unit, the charging unit comprising a second charge storage module configured to charge the first charge storage module and power the heater component; and
wherein the instructions cause the one or more processors to perform steps comprising:
determining that the holding unit is connected to the charging unit; and
pre-heating the heater component for an aerosolisation session by directing a power flow from the second charge storage module to the heater component when the holding unit is connected to the charging unit.
